(19) United States
(12) Patent Application Publication
(10) Pub. No.: US 2007/0022050 A1
(43) Pub. Date: Jan. 25, 2007

(54) INSTALLMENT PAYMENT SEARCHING SYSTEM, APPARATUS, AND METHOD

(76) Inventors: Stephen R. Cornaby, Yukon, OK (US); Michal Drew Carson, Oklahoma City, OK (US)

Correspondence Address: RAYMOND D. WEBB JR., 6 MIAMI AVE., SUITE 1, MIAMI, FL, 85539, US

(21) Appl. No.: 11/421,338

(22) Filed: May 31, 2006

Related U.S. Application Data
(60) Provisional application No. 60/686,555, filed on Jun. 1, 2005.

(51) Int. Cl. G06Q 40/00

(52) U.S. Cl. 705/40

(57) ABSTRACT

A lender provides a loan policy containing rules that relate item attributes and/or borrower characteristics to loan parameters such as interest rate and loan term. An inventory of items normally purchased is searched using an installment payment amount as a search criterion by combining item attributes and loan rules associated with loan parameters to identify items having installment payments that conform to the loan policy and satisfy payment search criteria.

### RELATED APPLICATIONS

This application claims priority to U.S. Provisional Patent Application No. 60/686,555 entitled “Shop by Price” and filed on 1 Jun. 2005 for Stephen R. Comaby, which is incorporated herein by reference.

### BACKGROUND OF THE INVENTION

1. Field of the Invention

The present invention relates to information search technologies and the exchange of services, information, and/or products from businesses to consumers, consumers to consumers, or businesses to businesses. In particular, embodiments of the present invention relate to apparatus, methods, and systems for searching by installment payment for property, goods, or services that are financed such as vehicles, real estate, and other large ticket items.

2. Description of the Related Art

The Internet is providing a shopping experience unparalled in history. With a few keystrokes and a mouse click, a user may search an inventory of hundreds of thousands of items for sale. FIG. 1 depicts a typical prior art system for online shopping 100 including a web server 110 connected to a user 115 via a network 120 such as the Internet. The depicted webserver 110 includes a database management system (DBMS) 125, a database 130, and a search module 135.

The user 115 transmits a search request including one or more desired item characteristics via the network 120 to the search module 135. The search module 135 assembles a search list 140, representing acceptable values or value ranges specified by the search request. Typical characteristics may be item name, classification, size, capacity, speed, color, price, and so forth. The DBMS 125 retrieves item attributes from the database 130 and passes them to the search module 135, which compares the item attributes with the search list 140. Items that match the search list 140 are displayed to the user.

Some databases store information about items that are relatively expensive such as real estate, automobiles, recreational vehicles, and airplanes. Most consumers finance these major purchases. Since a seller is usually not interested in loaning money to a buyer, a third party lending institution often becomes involved with the transaction, which adds confusion and cost to the purchase process.

A variety of lenders provide an array of installment payment plans with varying payment terms and interest rates. For example, a well known installment payment plan calls for 36 monthly payments at a specified interest rate. Moreover, a payment amount may be based on loan parameters such as an interest rate and loan term, which in turn may be determined by loan policy rules that consider attributes such as the age and price of the item and the credit worthiness of the buyer.

### BRIEF SUMMARY OF THE INVENTION

The purchase process for financed items tends to develop into a complicated combination of an item search and a payment search. Not only must the item meet a consumer's needs, but a loan must meet the consumer's ability to make the installment payments. Many buyers desire to simplify the purchase process by submitting a desired installment payment as a search criterion, much like they submit other item characteristics in a search request. Searching by installment payment may help a user to balance expectations with an affordable payment.

While current online shopping search engines allow a consumer to search for a financed item, such as an automobile, by item attributes such as a make, model, and purchase price, there is no real-time mechanism to search for financed items by installment payment. Accordingly, what is needed is an apparatus, method, and system to search by installment payment. The present invention has been developed in response to the present state of the art, and in particular, in response to the problems and needs in the art that have not yet been fully solved by currently available shopping search engine techniques. Accordingly, the present invention has been developed to provide an apparatus, method, and system for searching by installment payment that overcomes many or all of the above-discussed shortcomings in the art.

In one aspect of the present invention, an apparatus for searching by installment payment includes a policy module that receives a loan policy from a lender that sets forth rules to determine loan parameters, a user interface module that receives a payment search request from a user that sets forth payment search criteria, an attribute retrieval module that retrieves item attributes used to determine installment payments, and a search module that identifies one or more items that conform to the loan policy rules and satisfy the payment search criteria.

An apparatus for searching by installment payment is useful to easily identify the cash flow impact of a purchase, to highlight tradeoffs between what is wanted and what is affordable, and to find items that a user desires to purchase. The real time nature of the apparatus makes it useful as a tool for sales professionals that represent a large inventory of items that are normally financed, such as large auto dealerships or real estate, where decisions are often based on a monthly payment amount and financial institution loan policies change constantly.

In another aspect of the present invention, a method for searching by installment payment includes receiving a loan policy from a lender, receiving a payment search request from a user, and for each item in an inventory: retrieving an item's attributes relevant to the loan policy, applying loan policy rules to determine loan parameters such as loan term and interest rate, computing an installment payment using the loan paramaters and item attributes, and identifying whether the item satisfies the payment search request criteria.

In another aspect of the present invention, a method for associating an item with an installment payment includes receiving a loan policy from a lender, receiving an item search request from a user, and for each item in an inventory: retrieving an item's attributes, identifying an item that matches the item search request criteria, and determining an installment payment for the matching item based on the loan policy rules and item attributes. Various elements of the present invention are combined into a system for searching by installment payment that consists of a communication network and one or more servers containing a plurality of modules configured to functionally execute the necessary steps of searching by installment payment.

The present invention facilitates online identification and purchase of financed items by providing search capability by installment payment as well as by item attributes. Many buyers are more concerned about their monthly cash flow than about the item's list price. Search by installment payment supplies instant answers to cash flow questions.

The present invention also simplifies the process to purchase items wherein a seller, a buyer, and a lender are involved in the business transaction. The buyer does not need to understand the details of loan policy rules and the calculations necessary to convert loan parameters such as a financed amount, interest rate, and loan term into an installment payment. The buyer can save time by simultaneously interacting with the item attributes and the finance cost. The user can search for potential purchases by specifying an easy-to-understand installment payment metric, which is readily applied to a budget.

The present invention enables a closer working relationship between a lender and a seller, benefitting both parties. The lender may agree to provide installment payment information in response to sales inquiries for financed items such as vehicles or real estate in order to increase the capture rate of consumer loans, while a seller or sales agent may post inventory on a lender's web site in order to increase exposure to qualified buyers.

These and other features and advantages of the present invention will become more fully apparent from the following description and appended claims, or may be learned by the practice of the invention as set forth in the following sections.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only certain embodiments of the invention and are not therefore to be considered to be limiting of its scope, the invention will be described and explained with additional specificity and detail through the use of the accompanying drawings, in which:

FIG. 1 is a block diagram illustrating a typical prior art system for online shopping;

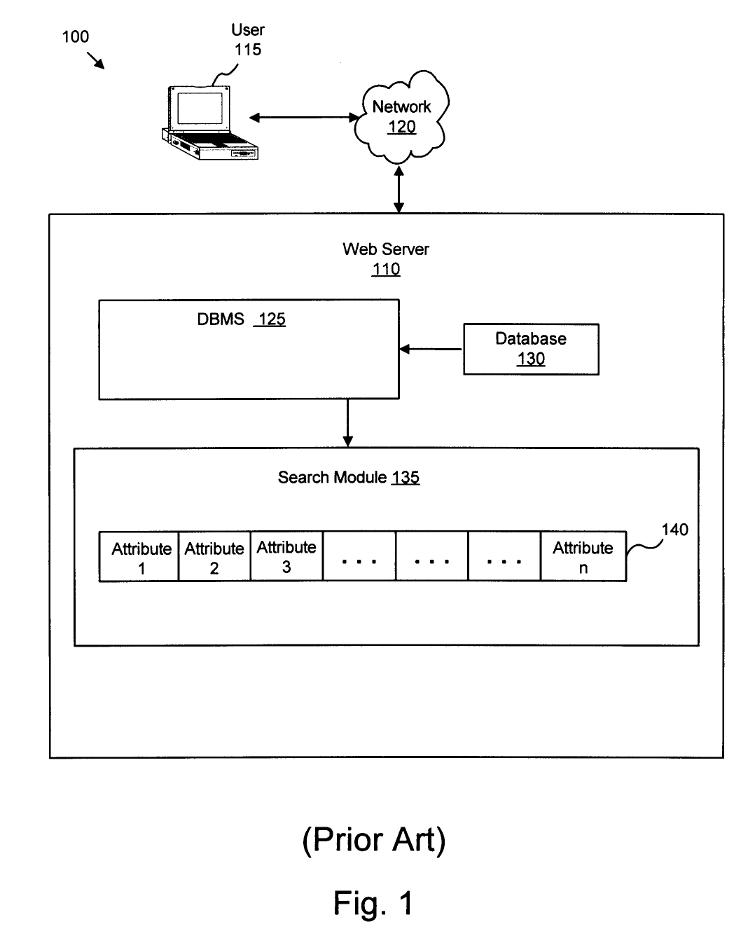

FIG. 2 is a block diagram illustrating one embodiment of a system for searching by installment payment;

FIG. 3 is a block diagram illustrating one embodiment of an apparatus for searching by installment payment;

FIG. 4 is a flow chart diagram illustrating one embodiment of a method for searching by installment payment; and

FIG. 5 is a flow chart diagram illustrating one embodiment of a method for associating an item with an installment payment.

### DETAILED DESCRIPTION OF THE INVENTION

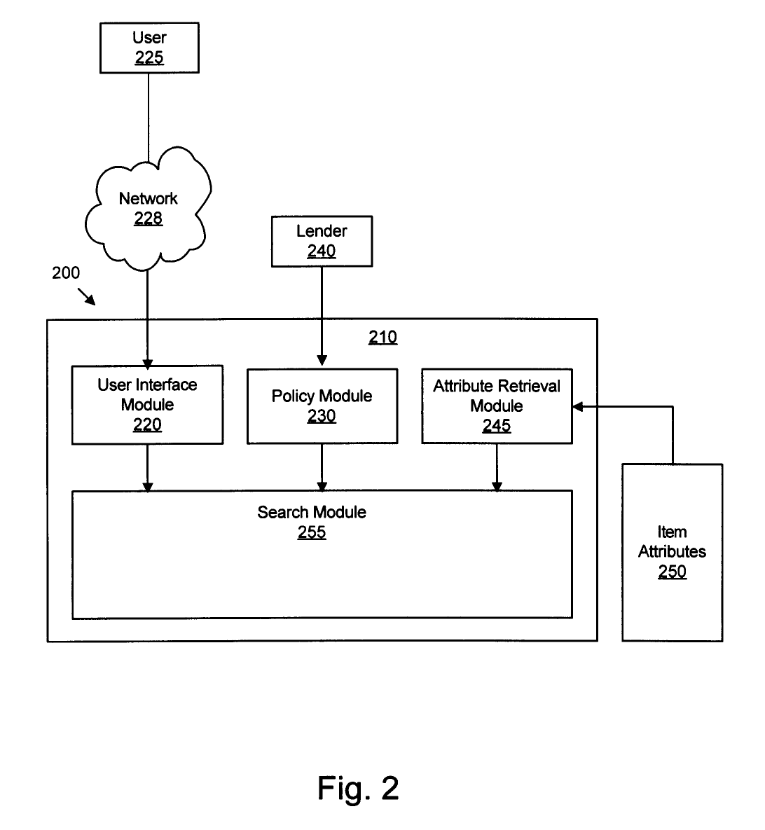

The components of the present invention, as generally described and illustrated in the included Figures, may be arranged and designed in a wide variety of different configurations. Thus, the following more detailed description of the embodiments of the apparatus, method, and system of the present invention, as represented in FIGS. 2 through 5, is not intended to limit the scope of the invention, as claimed, but is merely representative of selected embodiments of the invention.

Many of the functional units described in this specification have been labeled as modules in order to more particularly emphasize their implementation independence. For example, a module may be implemented as a hardware circuit comprising custom integrated circuits or gate arrays, off-the-shelf semiconductors such as logic chips, transistors, or other discrete components. A module may also be implemented in programmable hardware devices such as field programmable gate arrays, programmable array logic, programmable logic devices or the like. A module may further include interface hardware, such as connectors, cables, antennae, or the like.

Modules may also be implemented in software for execution by various types of processors. A module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to the term “embodiment” means that a particular feature, structure, or characteristic described in connection with the embodiment is included in at least one representation of the present invention. Thus, appearances of the phrase “in one embodiment” and the like in various places throughout this specification are not necessarily all referring to the same embodiment, and the described features, structures, or characteristics may be combined in any suitable manner in one or more embodiments.

Embodiments of the present invention may be provided as a computer program product, which may include a machine-readable medium having stored thereon instructions, which may be used to program a computer (or other electronic devices) to perform a process. Moreover, embodiments of the present invention may also be downloaded as a computer program product, wherein the program may be transferred from a remote computer to a requesting computer by way of data signals embodied in a carrier wave or other propagation medium via a communication link.

While an embodiment in the specification referring to a search by installment payment apparatus, method, and system may be described to facilitate purchase of a vehicle, other embodiments of the search by installment payment apparatus, method, and system are equally applicable to facilitating the sale of other financed purchases, such as recreational vehicles, boats, real estate, remodeling and home repairs. Likewise, while certain embodiments may refer to a search by installment payment apparatus, method, and system that is separate and independent of existing content search portals, other embodiments of the present invention are equally applicable to various other operational models.

For example, the search by installment payment apparatus and/or methods described herein may be integrated with or form part of a larger search engine, web site or portal. Indeed, certain embodiments of the present invention may be locally hosted and implemented as a separate or integral service within one or more well known shopping web sites, or might be directly accessible via an electronic or online banking web site. Alternatively, search by installment payment functionality may be provided in accordance with an Application Service Provider type model, wherein a search by installment payment system responds to payment search requests that originate with a web site that interacts directly with an end user.

Statements included herein that state a component or feature “may”, “can”, “could”, or “might” be included or have a characteristic, should be construed to mean that the particular component, feature, or characteristic is not required in all embodiments. The term “item” should be construed to mean any real estate or personal property, including but not limited to a vehicle, a boat, an airplane, a house, a plot of ground, or a recreational vehicle. The term “attribute” should be construed to mean information that describes an item. Attributes may be different for different categories of items. For example, real estate is a different category of item than vehicles, and attributes of real estate may include number of bedrooms, number of bathrooms, total square footage, and purchase price. On the other hand, items in the vehicle category may include attributes such as manufacturer, model, color, vehicle identification number (VIN), and year of manufacture. The term “user” should be construed to mean any entity that provides a payment search request and may include an end user, a web site, a search engine, a database, an agent, an internet bot, a daemon, and so forth.

FIG. 2 is a block diagram illustrating one embodiment of a system for searching by installment payment. The depicted search by installment payment system 200 includes a server 210 containing a user interface module 220 that communicates with a user 225 via a network 228, a policy module 230 that communicates with a lender 240, an attribute retrieval module 245 that retrieves item attributes 250, and a search module 255. The server 210 may include a processing element (not shown) and random access memory (not shown) as well as other electronic components. Attributes 250 may be stored in volatile or non-volatile memory (not shown), on a hard disk drive (not shown), in a remote system or server (not shown), or in some combination of these or other storage devices.

The user interface module 220 may receive a payment search request (PSR) from the user 225 via the network 228. The user interface module 220 may receive the PSR using a network 228 such as the Internet. In another embodiment, the user interface module 220 receives the PSR using a local area network 228, while in yet another embodiment the user interface module 220 receives the PSR using a wireless network 228.

The PSR may set forth a desired payment amount for use as a search criterion. The search criteria may also be expressed as a range of payments with an upper and a lower payment limit. In one embodiment, the PSR may incorporate one or more item attributes to use as search criteria. The PSR may contain a non-financed amount that is to be subtracted from an item price before determination of an installment payment. In one embodiment, the PSR contains one or more user attributes such as a credit score that may appear in a loan policy rule. The user interface module 220 may save the PSR.

The policy module 230 may receive a loan policy from one or more lenders 240. The loan policy may contain one or more rules that associate attributes and/or attribute ranges to loan parameters such as an interest rate and a loan term. The policy module 230 may accommodate multiple loan policies from the lender 240. In addition, the policy module 230 may receive loan policies from multiple lenders 240. In one embodiment, the policy module 230 stores one or more received loan polices and the search module 255 retrieves a relevant loan policy to determine an item's installment payment. The term “relevant loan policy” means the received loan policy that applies to the loan category and/or the lender associated with the user. For example, in the case of a user logged on to a bank website who requests an installment payment search for a vehicle, the relevant loan policy may be the vehicle loan policy from the bank that sponsored the website.

The attribute retrieval module 245 retrieves item attributes 250. In one embodiment, the attribute retrieval module 245 retrieves item attributes 250 contained in a local data storage device (not shown). In another embodiment, the attribute retrieval module 245 retrieves item attributes 250 by communicating with a storage device over a network 228 such as a WAN, a LAN, or a wireless network.

The search module 255 may respond to the user interface module 220 receiving a PSR by retrieving the relevant loan policy from the policy module 230, retrieving the PSR from the user interface module 220, and receiving item attributes 250 retrieved by the attribute retrieval module 245. The search module 255 may apply one or user attribute from the PSR and/or one or more item attributes 250 to determine loan parameters such as an interest rate and loan term, and then compute the item's installment payment amount. The search module 255 may compare the installment payment amount with the PSR criteria, and identify items that satisfy the PSR.

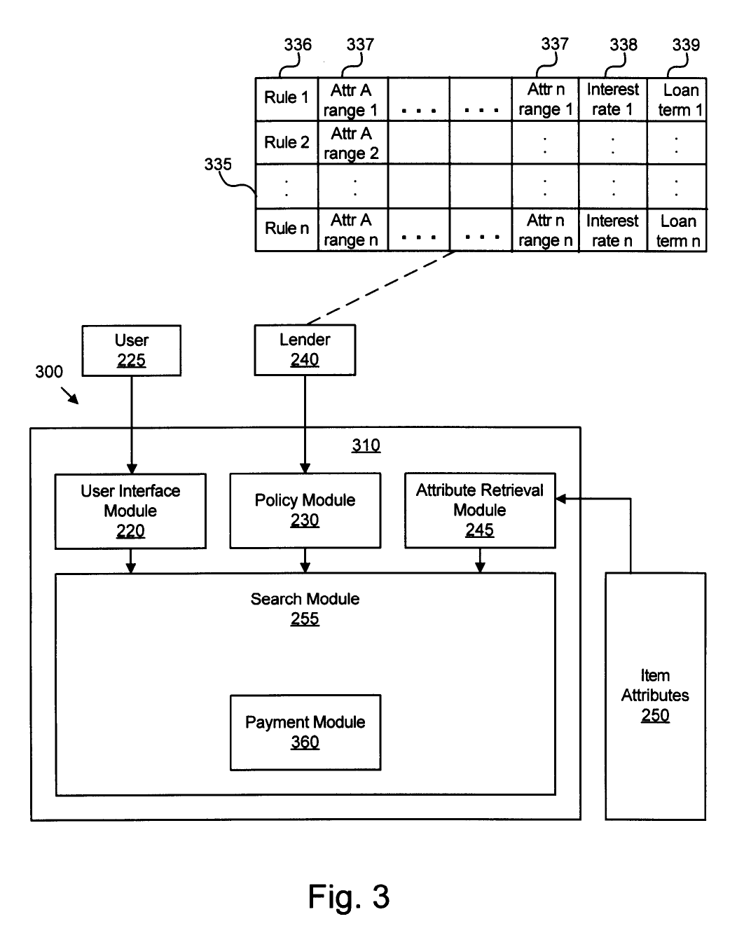

FIG. 3 is a block diagram illustrating one embodiment of an apparatus for searching by installment payment. The depicted search by installment payment apparatus 300 includes a search by payment module 310 that includes a user interface module 220 that communicates with a user 225, a policy module 230 that communicates with a lender 240 to receive a loan policy 335, an attribute retrieval module 245 that retrieves item attributes 250, and a search module 255 that includes a payment module 360.

The search by payment module 310 may incorporate a processing element (not shown) and random access memory (not shown) as well as other electronic components. Item attributes 250 may be stored in volatile or non-volatile memory (not shown), stored on a hard disk memory (not shown), or stored in memory devices on a remote system or server (not shown). In one embodiment, the search by payment apparatus 300 is implemented on a mobile platform.

The user interface module 220 receives a PSR from the user 225. The user interface module 220 may receive the PSR via a local input device, via a network such as the Internet, via the wireless telephone network, etc. The PSR may set forth a desired payment amount or payment range as a search criterion and may also include user attributes such as a credit score, item attribute search criteria, and/or a non-financed amount.

The policy module 230 receives a loan policy 335 from one or more lenders 240. The loan policy 335 represented in the illustrated embodiment as a table, contains one or more rules 336 including one or more criterion comprising attribute ranges 337. Each rule 336 is associated with one or more loan parameters such as an interest rate 338 and a loan term 339. The search module 255 compares an item attribute 250 value to an analogous attribute range 337. If the item attribute 250 value falls between the upper and lower attribute range 337 limits, the attribute satisfies a rule criterion.

For example, a simple auto loan policy has two rules, each rule including one criterion. Rule A associates a lower interest rate 338 and a longer loan term 339 with a vehicle manufactured less than two years previous, and rule B associates a a higher interest rate 338 and shorter loan term 339 with a vehicle manufactured earlier. In this case, a new vehicle satisfies the less than two year criteria, therefore the lower interest rate 338 and longer loan term 339 associated with rule A would apply. A loan policy rule 336 may include a user attribute such as a credit score and may associate a lower interest rate with a better credit score.

In one embodiment, the policy module 230 receives multiple loan policies 335 from a lender 240, each loan policy 335 applying to a different category of loans. For example, one loan policy may apply to automobile loans while another loan policy may apply to real estate loans. In another embodiment, the policy module 230 receives loan policies 335 from multiple lenders 240. If a PSR is received from a user 225 that is associated with a specific lender 240, that lender's loan policy 335 may be used to calculate an installment payment. For example, if a PSR is received from a user 225 that is logged on to a bank web site, the sponsoring bank's loan policy 335 may be used.

In another case, if a PSR is received from a user 225 that is associated with a location, a lender's loan policy 335 that serves that location may be applied to determine an installment payment. For example, a financial institution may sponsor a website including the search by installment payment apparatus 300 for certain zip codes where teller services are provided. A user living in a sponsored zip code may receive an installment payment determined by the sponsoring institution's loan policy 335. In another embodiment, loan policies 335 from multiple lenders 240 may be used to determine an installment payment, and information relating to the lender 240 with the lowest installment payment may be transmitted to the user 225.

The attribute retrieval module 245 retrieves item attributes 250. In one embodiment, the attributes 250 are contained in a database. Not all attributes 250 pertain to the loan policy 335. For example, whereas an age attribute range may often appear in a loan policy rule 336, a color attribute might not be included in a loan policy rule 336.

The search module 255 may respond to the user interface module 220 receiving a PSR by retrieving a relevant loan policy from the policy module 230, retrieving the PSR from the user interface module 220, and receiving item attributes 250 retrieved by the attribute retrieval module 245. The search module 355 may apply one or more loan policy rules 336 to determine a rule 336 that conforms to the item attributes 250. “Conforms” means that for every attribute range 337 included in a policy loan rule 336, an analogous item attribute 250 value falls within the attribute range 337 limits.

In one embodiment, the payment module 360 applies loan parameters such as the interest rate 338 and loan term 339 associated with a conformed policy rule 336 together with item attributes 250 such as the item price to determine an installment payment amount. The installment payment amount may be transmitted to the user. The search module 255 compares the installment payment amount with the PSR, and identifies an item that satisfies the PSR. “Satisfies” means that the installment payment amount matches the payment criteria included in a PSR, or that the installment payment amount falls between the lower and upper payment limits in a PSR having a range of payment criteria, and that the item attributes 250 match all PSR item attribute search criteria.

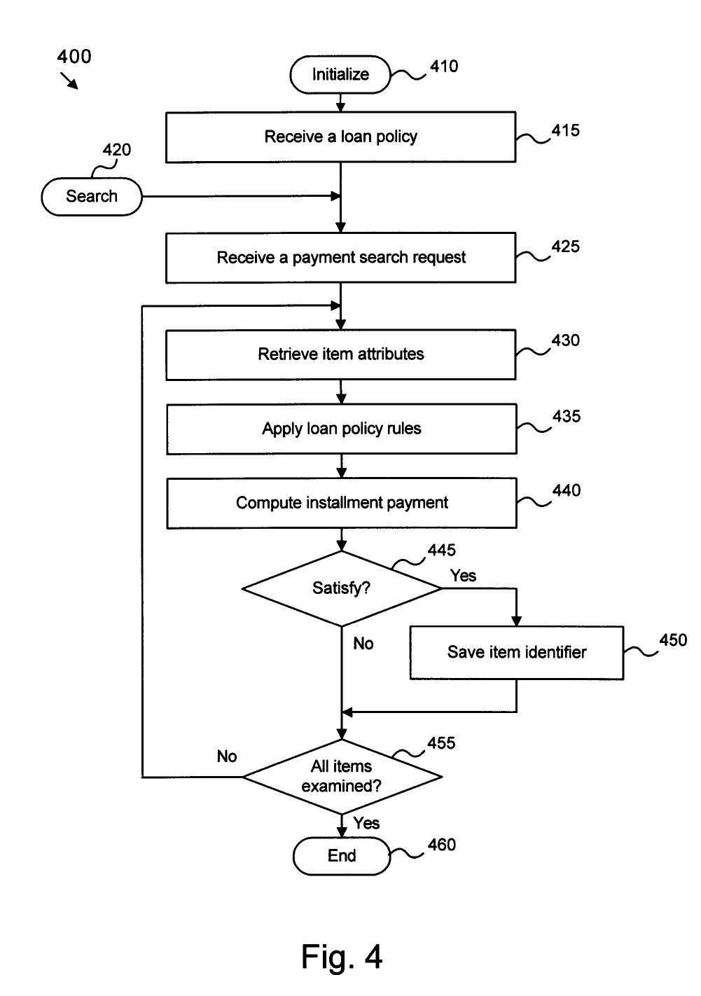

FIG. 4 is a flow chart diagram illustrating one embodiment of a method for searching by installment payment. The method 400 initializes 410 upon the start of an apparatus or system including the method 400, by the policy module 230 receiving 415 a loan policy 335 from a lender 240. The loan policy 335 contains one or more rules 336 that relate item attributes and/or attribute ranges 337 to loan parameters such as an interest rate 338 and a loan term 339. In the depicted embodiment, at least one loan policy 335 must be received before the method is operationally valid.

After initialization, the method 400 may search 420 by the user interface module 220 receiving 425 a PSR, which specifies an installment payment amount or payment range as a search criterion. In one embodiment item attribute search criteria, user attributes such as a credit score, and/or user information such as a non-financed amount may be included in the PSR.

Subsequently, the attribute retrieval module 245 retrieves 430 one or more item attributes that are relevant to the loan policy. The search module 255 applies 435 the loan policy rules 336 to the attributes 250 to determine a rule 336 that conforms to the attributes 250 and determines the loan parameters associated with the rule 336. Thereafter, the search module 255 computes 440 an installment payment value using the item attributes 250 and the loan parameters. In one embodiment, the search module 255 first subtracts a non-financed amount included in a PSR from the item cost before computing 440 an installment payment value.

If the installment payment value satisfies 445 the PSR, the search module 255 saves 450 an item identifier for transmission to the user. After saving 450 or after determining that the installment payment did not satisfy 445 the PSR, the search module 255 determines 455 if all items have been examined. If at least one item remains, control is transferred to step 430, otherwise the method 400 ends 460.

For example, in one embodiment of the method 400, a person interested in buying a vehicle (“the user”) navigates to a financial institution (“the lender”) web page that embodies the search by installment payment method 400. The method 400 previously received 415 an auto loan policy 235 from the lender 240. The auto loan policy 235 included one or more rules, each rule associating an interest rate 338 and loan term 339 with one or more vehicle attribute ranges 337. The attribute ranges 337 may concern vehicle make, model, price, and year of manufacture. The user 225 enters a payment search request including a desired installment payment amount, an upper payment limit, and a non-financed amount.

The payment search request is received by the user interface module 220, and the search module 255 receives vehicle attributes 250 from the attribute retrieval module 245 corresponding to a vehicle in the bank site vehicle inventory. The search module 255 computes 440 an installment payment amount by: first, applying the one or more received rules 336 to the vehicle attributes 250 and establishing the loan term and interest rate associated with a conforming rule, and second, formulating an installment payment amount by subtracting the non-financed amount from the vehicle price to produce a financed amount and subsequently computing the installment payment amount utilizing the interest rate, the loan term, and the financed amount.

The search module 255 then compares 445 the computed installment payment amount with the payment search request. If the installment payment amount satisfies the payment search request, the search module 255 saves 450 an item identifier and the installment payment value, and proceeds to examine the next vehicle in the inventory. After all vehicles have been examined 455, the search module 225 transmits the item identifiers and installment payment values of all vehicles that satisfied the payment search request to the user 225.

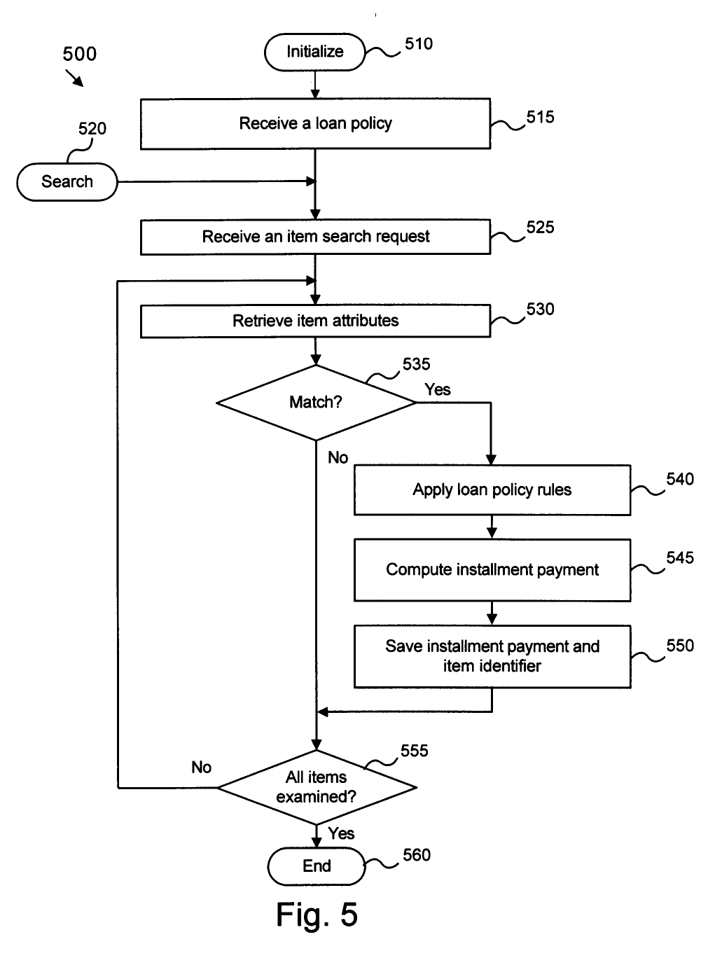

FIG. 5 is a flow chart illustrating one embodiment of a method for associating an item with an installment payment. The method 500 initializes 510 upon the start of an apparatus or system that incorporates the method 500, by the policy module 230 receiving 515 a loan policy 335 from a lender 240. After receiving 515 the loan policy 335, a search 420 may begin by the user interface module 220 receiving 525 an item search request, which may specify one or more item attributes as search criteria. The attribute retrieval module 245 then retrieves 530 item attributes 250. The search module 255 compares the item attributes 250 with analogous item search request search criteria. If the item attributes match 535 the item search request search criteria, the search module 255 applies 540 one or more loan policy rules 336 to the item attributes 250 to determine a rule 336 that conforms to the attributes 250 and determines the loan parameters associated with the conforming rule. Subsequently, the search module 255 computes 545 an installment payment amount using the item attributes and the loan parameters.

The search module 255 saves 550 an item identifier and the installment payment for transmission to the user 225. After saving 550 or after determining that the item attributes did not match 535 the item search request criteria, the search module 255 determines 555 if all items have been examined. If at least one item remains, control is transferred to step 530, otherwise the method 500 ends 560.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for searching for a vehicle by installment payment, the method: comprising:
receiving a loan policy from a lender, the policy comprising at least one rule that associates a loan term and an interest rate with one or more vehicle attribute selected from the group consisting of a vehicle make, a vehicle model, a vehicle price, and a vehicle year;
receiving a payment search request from a user, the request comprising a payment criteria;
retrieving, from a database, vehicle attributes relevant to the loan policy;
determining an installment payment amount for the vehicle, the determining comprising:
identifying a loan policy rule that conforms to vehicle attributes relevant to the loan policy,
establishing an interest rate and loan term associated with the loan policy rule, and
formulating an installment payment amount utilizing the loan term, the interest rate, and a vehicle purchase price associated with the vehicle;
comparing the installment payment amount with the payment search request; and
transmitting to the user information associated with a vehicle that satisfies the payment criteria.

2. An apparatus for searching by installment payment, the apparatus comprising:
a policy module configured to receive a loan policy from a lender;
a user interface module configured to receive a payment search request from a user;
an attribute retrieval module configured to retrieve item attributes pertaining to the loan policy for a plurality of items; and
a search module configured to identify at least one item that conforms to the loan policy and satisfies the payment search request.

3. The apparatus of claim 2, further comprising a payment module configured to determine an installment payment that conforms to the loan policy.

4. The apparatus of claim 2, wherein the payment search request comprises an installment payment range with a lower payment limit and an upper payment limit.

5. The apparatus of claim 2, wherein the payment search request further comprises a non-financed amount.

6. The apparatus of claim 2, wherein the user interface module is further configured to receive an item search request from a user.

7. The apparatus of claim 2, wherein the payment search request further comprises a credit score.

8. The apparatus of claim 7, wherein the loan policy comprises at least one rule incorporating a credit score range.

9. A method for searching by installment payment, the method comprising:
receiving a loan policy from a lender;
receiving a payment search request from a user,
retrieving item attributes relevant to the loan policy for a plurality of items; and
identifying at least one item that conforms to the loan policy and satisfies the payment search request.

10. The method of claim 9, further comprising transmitting attributes of the at least one item to the user.

11. A method for associating items with installment payments; the method comprising:
receiving a loan policy from a lender;
receiving item attribute criteria from a user,
identifying at least one item matching the item attribute search criteria; and
determining an installment payment conforming to the loan policy for the at least one item.

12. The method of claim 11, further comprising transmitting the installment payment for the at least one item to the user.

13. A system for searching by installment payment, the system comprising:
at least one server comprising:
a policy module configured to receive a loan policy from a lender,
a user interface module configured to receive a payment search request from a user,
an attribute retrieval module configured to retrieve item attributes relevant to the loan policy for a plurality of items, and
a search module configured to identify at least one item that conforms to the loan policy and satisfies the payment search request.

14. A computer readable storage medium comprising computer readable program code for searching by installment payment, the program code configured to:
receive a loan policy from a lender;
receive a payment search request from a user;
retrieve item attributes relevant to the loan policy for a plurality of items; and
identify at least one item that conforms to the loan policy and satisfies the payment search request.
